(19) United States
(12) Patent Application Publication
(10) Pub. No.: US 2008/0088775 A1
(43) Pub. Date: Apr. 17, 2008

(54) Multi-domain transflective liquid crystal display

(75) Inventors: Yi-Chun Wu, Hua Lien City (TW); Chian-Chang Lee, Tai Chung City (TW)

Correspondence Address: BIRCH STEWART KOLASCH & BIRCH, PO BOX 747, FALLS CHURCH, VA, 22040-0747, US

(73) Assignee: Wintek Corporation

(21) Appl. No.: 11/896,629

(22) Filed: Sep. 4, 2007

(30) Foreign Application Priority Data
Oct. 12, 2006 (TW) 095137472

(51) Int. Cl. G02F 1/1335

(52) U.S. Cl. 349/114

(57) ABSTRACT

A multi-domain transflective liquid crystal display includes a plurality of picture elements each having a reflective region and a transmissive region. The reflective region and the transmissive region both have a plurality of orientation-divided domains with liquid crystal molecules in an individual domain having substantially the same orientation direction, and an azimuth difference of substantial 45 degrees exists between the distribution of the orientation directions of liquid crystal molecules in the reflective region and that in the transmissive region.

### BACKGROUND OF THE INVENTION

(a) Field of the Invention

The invention relates to a multi-domain transflective liquid crystal display, particularly to a multi-domain transflective liquid crystal display where the domain arrangement for forming multiple orientation-divided domains in the reflective regions is different to that in the transmissive regions to obtain optimum optical performance.

(b) Description of the Related Art

FIG. 1 shows a schematic cross-section of a conventional liquid crystal display that includes a circular polarizer. Referring to FIG. 1, the liquid crystal display 100 includes a color filter substrate 102 and an array substrate 104, with a liquid crystal layer 106 having negative dielectric anisotropy interposed between them. In the array substrate 104, a plurality of pixel electrodes 112 and a first alignment layer 114 are formed on a transparent substrate 108. Further, in the color filter substrate 102, color filters 118, a black matrix layer 122, a common electrode 124, and a second alignment layer 126 are formed on a transparent substrate 116.

A lower linear polarizer 128 is positioned on one side of the transparent substrate 108 and opposite to the liquid crystal layer 106, and an upper linear polarizer 132 is positioned on one side of the transparent substrate 116 and opposite to the liquid crystal layer 106. The absorption axis of the lower linear polarizer 128 is perpendicular to that of the upper linear polarizer 132. Besides, a first quarter wave plate 134 and a second quarter wave plate 136 are respectively provided between the transparent substrate 108 and the linear polarizer 128 and between the transparent substrate 116 and the linear polarizer 132. Thus, a linear polarizer together with a quarter wave plate constitutes a circular polarizer.

When no voltage is applied across the common electrode 124 and the pixel electrode 112, most liquid crystal (LC) molecules are vertically aligned in relation to the transparent substrates 108 and 116. At this time, an unpolarized light beam is converted into a left-hand circularly polarized light beam after it passes through a linear polarizer 128 and a quarter wave plate 134 in succession. Since the polarization state of a light beam will not be converted to any other polarization state when it passes through vertically aligned liquid crystal molecules, the left-hand circularly polarized light beam then fails to pass a right-hand circular polarizer that consists of the linear polarizer 132 and the quarter wave plate 136 to result in a dark state.

In contrast, when a voltage is applied across the common electrode 124 and the pixel electrode 112, most LC molecules are tilted to substantially parallel to the transparent substrates 108 and 116. At this time, an unpolarized light beam is converted into a left-hand circularly polarized light beam after it passes through a linear polarizer 128 and a quarter wave plate 134 in succession. Then, the left-hand circularly polarized light beam is converted into a right-hand circularly polarized light beam after passing through the liquid crystal layer 106, and the right-hand circularly polarized light beam can pass a right-hand circularly polarizer that consists of the linear polarizer 132 and the quarter wave plate 136 to result in a bright state.

Assume the circularly polarized light propagates along the Z axis, its electric field vector can always be decomposed into two orthogonal components Ex and Ey that make an angle of 45 degrees with the long axis of an LC molecule. Thus, the circularly polarized light may achieve the same phase difference even if it passes through LC molecules having mutually different orientations to obtain a maximum light transmittance.

Further, it is widely known that viewing angle performance of a liquid crystal display in a vertically aligned (VA) mode, which uses negative liquid crystal materials and vertical alignment films, can be improved by setting the orientation of LC molecules inside a pixel to a plurality of mutually different directions; that is, forming multiple orientation-divided LC domains with LC molecules in an individual domain having substantially the same orientation direction. For example, as shown in FIG. 2, protrusions 204 having different inclined surfaces formed on a transparent substrate 202 may divide the orientation of LC molecules 206 into mutually different directions. Alternatively, referring to FIG. 3, the transparent electrode 208 is provided with a pattern of slits 210 to produce fringe electric fields used to tilt LC molecules 206.

Moreover, in order to provide good visibility in any environment, a multi-domain liquid crystal display is designed to have both reflective regions and transmissive regions so as to make use of both ambient light and backlight. However, in the conventional multi-domain transflective liquid crystal display where a circular polarizer is incorporated to improve light utilization efficiency, the domain arrangement for forming multiple domains in the reflective regions is the same as that in the transmissive regions to cause inferior optical performance.

### BRIEF SUMMARY OF THE INVENTION

Hence, an object of the invention is to provide a multi-domain transflective liquid crystal display where the domain arrangement for forming multiple orientation-divided domains in the reflective regions is different to that in the transmissive regions to obtain optimum optical performance.

According to an aspect of the invention, a multi-domain transflective liquid crystal display includes a first and a second transparent substrates, a liquid crystal layer, a first and a second polarizers, a first and a second retarders, and a plurality of domain-forming structures. The first polarizer is positioned on one side of the first transparent substrate and opposite to the liquid crystal layer, and the second polarizer is positioned on one side of the second transparent substrate and opposite to the liquid crystal layer. The first retarder is provided between the first polarizer and the first substrate, and the second retarder is provided between the second polarizer and the second substrate. The domain-forming structures are used for separately regulating the orientation of liquid crystal molecules in the reflective regions and the transmissive regions of the multi-domain transflective liquid crystal display. The liquid crystal director in each domain of the reflective region makes an angle of substantial 45 degrees or 135 degrees with the slow axis of the first or the second retarders, and the liquid crystal director in each domain of the transmissive region makes an angle of substantial 0 degree or 90 degrees with the slow axes of the first and the second retarders. Further, the domain-forming structure may be a protrusion structure or a pattern of slits formed on electrodes. Also, the retarders may be quarter wave plates and the polarizers may be linear polarizers.

The invention provides two different domain-regulation arrangements respectively for the reflective region and the transmissive region, so that an azimuth difference exists between the distribution of orientation directions of LC molecules in the reflective region and that in the transmissive region. Under the circumstance, a maximum light transmittance and light reflectance as well as a high light utilization efficiency is obtained as the included angle between the LC director in the reflective region and the slow axis of the retarder is selected as substantial 45 degrees or 135 degrees, and the included angle between the LC director in the transmissive region Tr and the slow axis of the retarder is selected as substantial 0 degree or 90 degrees.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 shows a schematic cross-section of a conventional liquid crystal display that includes a circular polarizer.

FIG. 2 shows a schematic cross-section illustrating an embodiment of a conventional domain-forming structure.

FIG. 3 shows a schematic cross-section illustrating another embodiment of a conventional domain-forming structure.

FIGS. 4A and 5A show schematic diagrams illustrating two different optical arrangements for the reflective regions of a multi-domain transflective liquid crystal display according to the invention, and FIGS. 4B and 5B show curve diagrams illustrating the V-R characteristics of the optical arrangements as in FIGS. 4A and 5A, respectively.

FIGS. 6A and 7A show schematic diagrams illustrating two different optical arrangements for the transmissive regions of a multi-domain transflective liquid crystal display according to the invention, and FIGS. 6B and 7B show curve diagrams illustrating the V-T characteristics of the optical arrangements as in FIGS. 6A and 7A, respectively.

FIG. 8 shows a schematic diagram illustrating a picture element including both a transmissive region and a reflective region according to the invention.

### DETAILED DESCRIPTION OF THE INVENTION

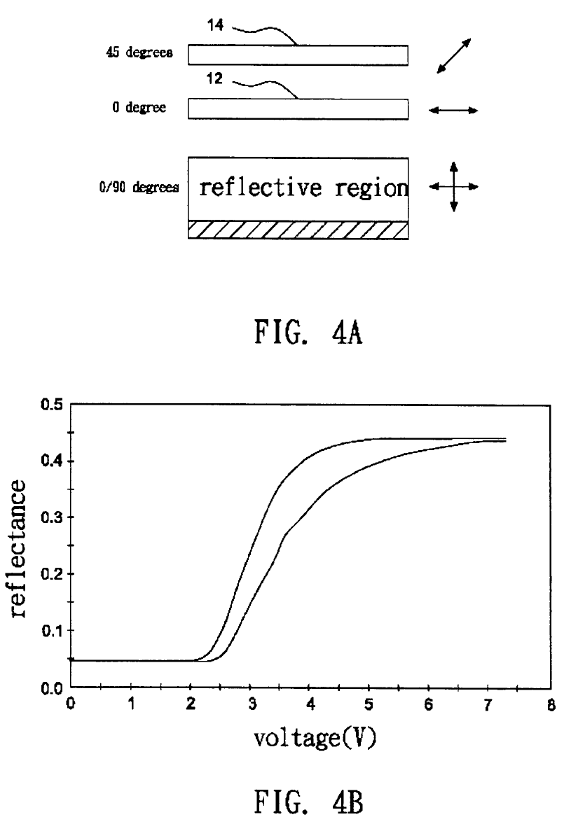

In a multi-domain transflective liquid crystal display, the reflective region and the transmissive region have their respective optical characteristics when light travel therethrough. Hence, the invention provides two different domain-regulation arrangements respectively for the reflective region and the transmissive region to obtain optimum light transmission and light reflection, under the circumstance where a transflective liquid crystal (LC) cell is combined with a circular polarizer. FIGS. 4A, 5A, 6A and 7A schematically show different arrangements of the optical matching of a transflective LC cell and a circular polarizer, where the arrows indicate the orientation direction of LC molecules (the long axis direction or the orientation of an LC director) in individual domain and the orientation of the axes of retarders and linear polarizers. Besides, FIGS. 4B, 5B, 6B and 7B depict the optical responses (the transmittance or reflectance versus voltage) related to the above arrangements of optical matching.

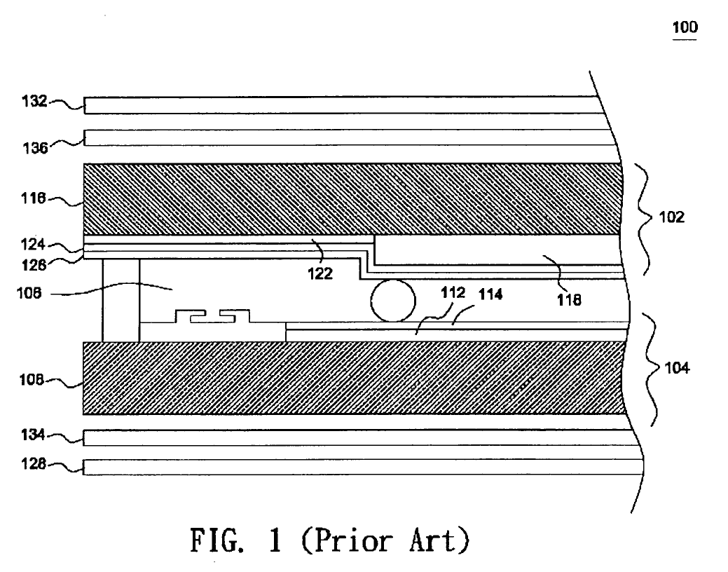

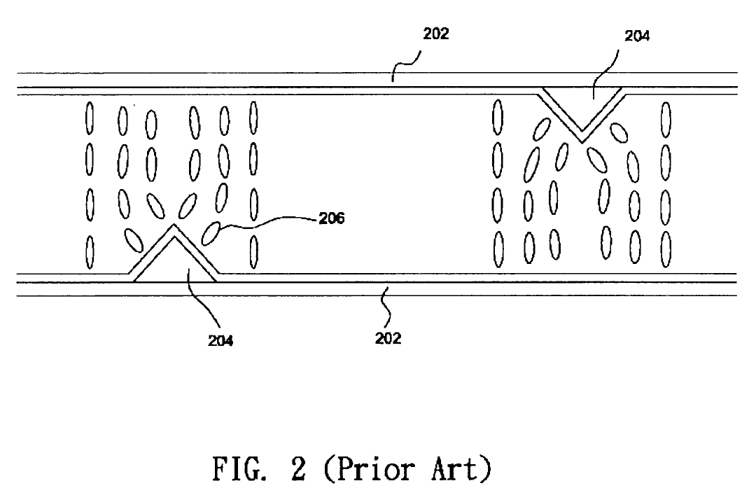

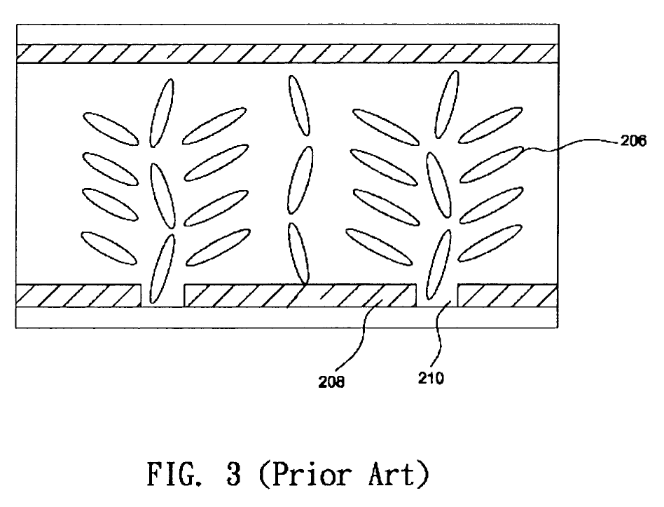

According to the invention, the domain-forming structure provided on each picture element, such as the protrusions shown in FIG. 2 or the pattern of slits shown in FIG. 3, have different stretches in the reflective region and in the transmissive region, and the angles between the orientation of the LC director and the axes of the retarders and linear polarizers are particularly defined to obtain a maximum light transmittance and light reflectance. Since the structure of a transflective LC cell, the domain-forming structure such as protrusions or a pattern of slits, and the structure of a circular polarizer according to the invention are similar to the conventional design as shown in FIGS. 1 to 3, they are not described in detail here. The different optical arrangements and their respective optical responses for the reflective region and for the transmissive region according to the invention are explained in detail as follows.

1. Reflective Region

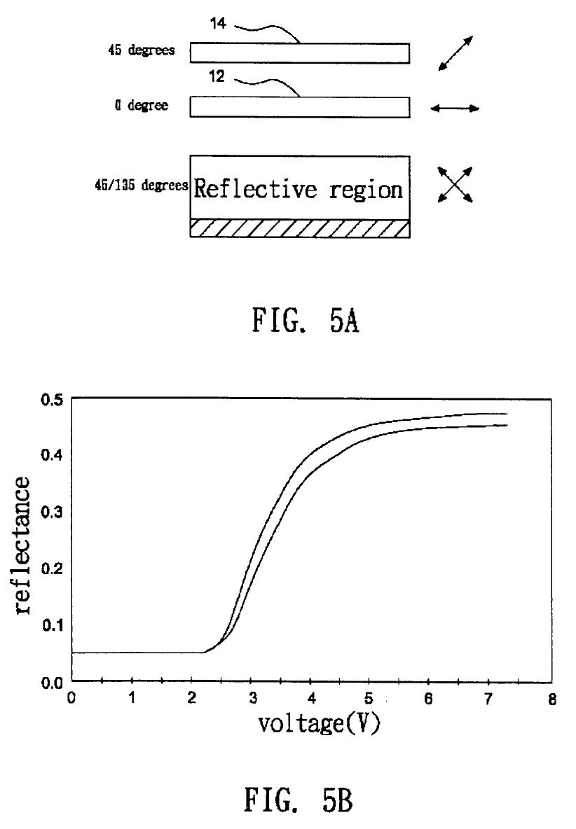

FIGS. 4A and 5A show schematic diagrams illustrating two different optical arrangements for the reflective regions of a multi-domain transflective liquid crystal display, in which a linear polarizer and a retarder are used to produce circularly polarized light. FIGS. 4B and 5B show curve diagrams illustrating the V-R characteristics (voltage versus light reflectance) of the optical arrangements as in FIGS. 4A and 5A, respectively.

As shown in FIG. 4A, by adjusting the stretch of a domain-forming structure, in each domain the orientation of a LC director in the reflective region of each picture element makes an angle of substantial 0 degree or 90 degrees with the slow axis of a quarter wave plate 12. Further, the angle between the slow axis of the quarter wave plate 12 and the absorption axis of a linear polarizer 14 is substantially 45 degrees. The V-R characteristics of the above optical arrangement are depicted in FIG. 4B. FIG. 4B shows two curves that depict the reflectance values observed from two separate viewing angles and an average of them represents the actual reflected light intensity sensed by the human eye and provided for the comparison of different optical arrangements. Also, the V-R characteristics shown in FIG. 5B are depicted in two curves with respect to two separate viewing angles.

FIG. 5A shows another optical arrangement for the reflective regions of a multi-domain transflective liquid crystal display. By adjusting the stretch of a domain-forming structure, in each domain the orientation of a LC director in the reflective region of each picture element makes an angle of substantial 45 degrees or 135 degrees with the slow axis of a quarter wave plate 12. The V-R characteristics of the above optical arrangement are depicted in FIG. 5B.

Comparing the respective V-R characteristics shown in FIG. 4B and FIG. 5B, it can be seen the average light reflectance is higher and a smoother curve is obtained when the LC director in the reflective region makes an angle of substantial 45 degrees or 135 degrees with the slow axis of the quarter wave plate 12. This is because, when light passes through a liquid crystal layer in which the LC director makes an angle of substantial 45 degrees or 135 degrees with the slow axis of the retarder, its two mutually orthogonal components X and Y of electric field vector have the same amplitude.

2. Transmissive Region

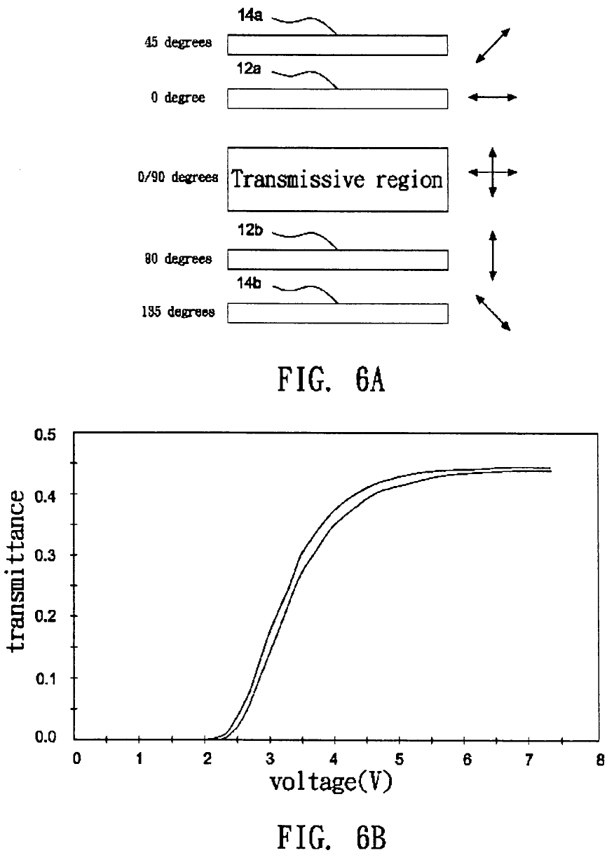

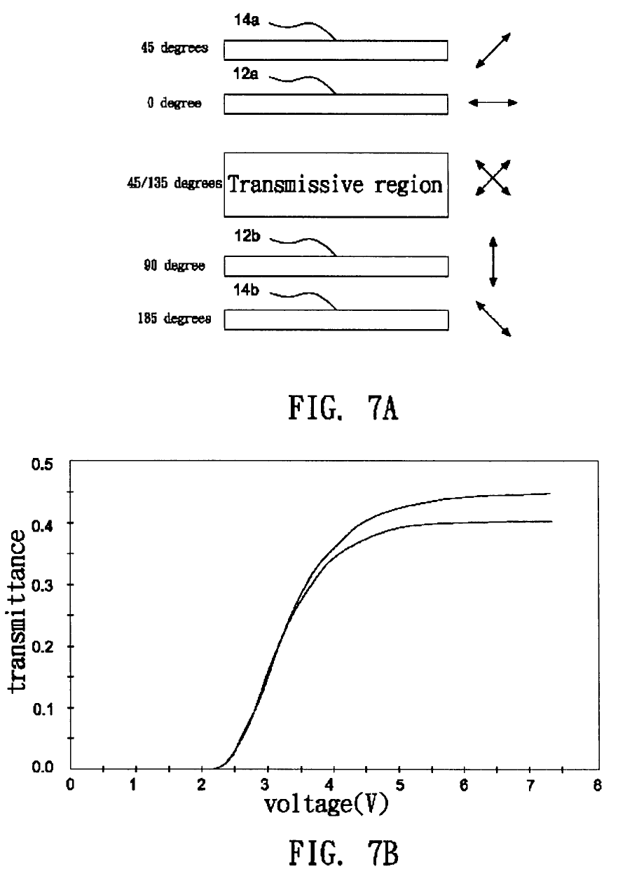

FIGS. 6A and 7A show schematic diagrams illustrating two different domain arrangements for the transmissive regions of a multi-domain transflective liquid crystal display, in which a linear polarizer and a retarder are used to produce circularly polarized light. FIGS. 6B and 7B show curve diagrams illustrating the V-T characteristics (voltage versus light transmittance) of the optical arrangements as in FIGS. 6A and 7A, respectively.

As shown in FIG. 6A, by adjusting the stretch of a domain-forming structure, in each domain the orientation of a LC director in the transmissive region of each picture element makes an angle of substantial 0 degree or 90 degrees with the slow axis of both a top quarter wave plate 12a and a bottom quarter wave plate 12b. Further, the angle between the slow axis of the top quarter wave plate 12a and the absorption axis of an upper polarizer 14a is substantially 45 degrees, and the angle between the slow axis of the bottom quarter wave plate 12b and the absorption axis of a lower polarizer 14b is substantially 135 degrees. Besides, the slow axis of the top quarter wave plate 12a is perpendicular to that of the bottom quarter wave plate 12b. The V-T characteristics of the above optical arrangement are depicted in FIG. 6B. FIG. 6B shows two curves that depict the transmittance values observed from two separate viewing angles, and an average of them represents the actual transmitted light intensity sensed by the human eye and provided for the comparison of different optical arrangements. Also, the V-T characteristics shown in FIG. 7B are depicted in two curves with respect to two separate viewing angles.

FIG. 7A shows another domain arrangement for the transmissive regions of a multi-domain transflective liquid crystal display. As shown in FIG. 7A, by adjusting the stretch of a domain-forming structure, in each domain the orientation of a LC director in the transmissive region of each picture element makes an angle of substantial 45 degrees or 135 degrees with the slow axis of both a top quarter wave plate 12a and a bottom quarter wave plate 12b. Further, the angle between the slow axis of the top quarter wave plate 12a and the absorption axis of an upper polarizer 14a is substantially 45 degrees, and the angle between the slow axis of the bottom quarter wave plate 12b and the absorption axis of a lower polarizer 14b is substantially 135 degrees. Besides, the slow axis of the top quarter wave plate 12a is perpendicular to that of the bottom quarter wave plate 12b. The V-T characteristics of the above optical arrangement are depicted in FIG. 7B.

Comparing the respective V-T characteristics shown in FIG. 6B and FIG. 7B, it can be seen the average light transmittance is higher when the liquid crystal director in the transmissive region makes an angle of substantial 0 degree or 90 degrees with the slow axis of the retarder. In that case, because the two quarter wave plates respectively provided on both sides of an LC cell have mutually perpendicular slow axes, the phase retardation effects brought by the two quarter wave plates will cancel each other out, and thus the angular relationship between an LC director and the absorption axis of a polarizer is the dominant factor for deciding the magnitude of the light transmittance. Under the circumstance, an included angle of 0 degree or 90 degrees between the LC director and the retarder results in an included angle of 45 degrees or 135 degrees between the LC director and the absorption axis of the polarizer to obtain an maximum light transmittance.

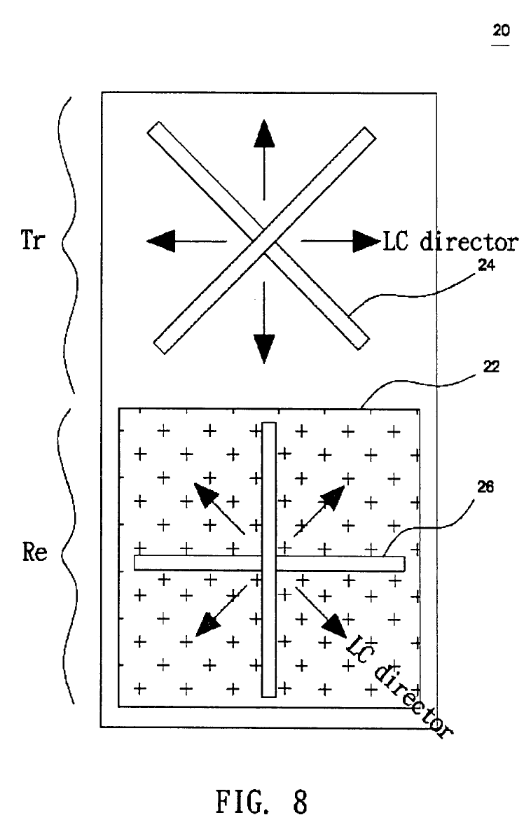

FIG. 8 shows a schematic diagram illustrating a picture element 20 including both a transmissive region Tr and a reflective region Re. A first domain-forming structure 24 and a second domain-forming structure 26 are respectively formed on the transmission region Tr and the reflective region Re. The domain-forming structure, which may be the protrusions shown in FIG. 2 or a pattern of slits shown in FIG. 3, may be line-shaped to define a specific stretch. Further, the arrows shown in FIG. 8 indicate the orientation direction (the long axis direction) of LC molecules that are tilted as a result of the domain-forming structure.

According to the invention, the stretches of the domain-forming structures in the transmissive region Tr and in the reflective region Re are individually adjusted according to the orientation of the axes of the retarder and the linear polarizer to obtain a maximum light transmittance and light reflectance. For instance, as shown in FIG. 8, an azimuth difference of 45 degrees is provided between the stretch of the domain-forming structure 24 in the transmissive region Tr with respect to that in the reflective region Re, so that an azimuth difference of substantial 45 degrees exists between the distribution of orientation directions of LC molecules in the reflective region Re and that in the transmissive region Tr. More specifically, a maximum light transmittance and light reflectance is obtained in case the included angle between the LC director in the reflective region Re and the slow axis of the retarder is selected as substantial 45 degrees or 135 degrees, and the included angle between the LC director in the transmissive region Tr and the slow axis of the retarder is selected as substantial 0 degree or 90 degrees. As a result, the light utilization efficiency is also improved.

While the invention has been described by way of examples and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A multi-domain transflective liquid crystal display, comprising:
a plurality of picture elements each having a reflective region and a transmissive region, wherein the reflective region and the transmissive region both have a plurality of orientation-divided domains with liquid crystal molecules in an individual domain having substantially the same orientation direction, and an azimuth difference of substantial 45 degrees exists between the distribution of the orientation directions of liquid crystal molecules in the reflective region and that in the transmissive region.

2. The multi-domain transflective liquid crystal display as claimed in claim 1, wherein both of the reflective region and the transmissive region are provided with a domain-forming structure, and the stretch of the domain-forming structure in the reflective region is different to that in the transmissive region.

3. The multi-domain transflective liquid crystal display as claimed in claim 1, wherein the domain-forming structure is a protrusion structure.

4. The multi-domain transflective liquid crystal display as claimed in claim 1, wherein the domain-forming structure is a pattern of slits formed on electrodes.

5. A multi-domain transflective liquid crystal display, comprising:
a first and a second transparent substrates facing to each other;
a liquid crystal layer having negative dielectric anisotropy interposed between the first and the second transparent substrates;
a first polarizer positioned on one side of the first transparent substrate and opposite to the liquid crystal layer;
a second polarizer positioned on one side of the second transparent substrate and opposite to the liquid crystal layer;
a first retarder provided between the first polarizer and the first substrate;
a second retarder provided between the second polarizer and the second substrate; and
a plurality of domain-forming structures for separately regulating the orientation of liquid crystal molecules in the reflective regions and the transmissive regions of the multi-domain transflective liquid crystal display;
wherein the liquid crystal director in each domain of the reflective region makes an angle of substantial 45 degrees or 135 degrees with the slow axis of the first or the second retarders, and the liquid crystal director in each domain of the transmissive region makes an angle of substantial 0 degree or 90 degrees with the slow axes of the first and the second retarders.

6. The multi-domain transflective liquid crystal display as claimed in claim 5, wherein the slow axes of the first and the second retarders are perpendicular to each other.

7. The multi-domain transflective liquid crystal display as claimed in claim 5, wherein the retarders are quarter wave plates and the polarizers are linear polarizers.

8. The multi-domain transflective liquid crystal display as claimed in claim 7, wherein the slow axes of the quarter wave plates make an angle of substantial 45 degrees or 135 degrees with the absorption axes of the linear polarizers.

9. The multi-domain transflective liquid crystal display as claimed in claim 5, wherein the domain-forming structure is a protrusion structure.

10. The multi-domain transflective liquid crystal display as claimed in claim 5, wherein the domain-forming structure is a pattern of slits formed on electrodes.
